(19) United States
(12) Patent Application Publication
(10) Pub. No.: US 2003/0003961 A1
(43) Pub. Date: Jan. 2, 2003

(54) Sequential signal selection system and method

(76) Inventors: Kuo-Hui Li, Redmond, WA (US); James Stevenson Kenney, Atlanta, GA (US); Mary Ann Ingram, Decatur, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/896,080

(22) Filed: Jun. 30, 2001

(51) Int. Cl. H04M 1/00

(52) U.S. Cl. 455/562; 455/12.1

(57) ABSTRACT

The sequential signal selection system and method is generally related to communication systems and more particularly to a system and method for sequentially selecting signals from a set of signal(s). The sequential signal selection comprises a processor, a memory device that is coupled to the processor, at least one radio/transceiver that is coupled to the processor, and an analog pre-selection network that is coupled to the at least one radio/transceiver. Moreover, the sequential signal selection method comprises the steps of pre-selecting at least two signals from a set of signals based on a pre-selection method, and selecting at least one signal from the at least two signals based on a selection method.

### TECHNICAL FIELD

The present invention is generally related to communication systems and, more particularly, is related to a system and method for sequentially selecting signal(s) from a set of signals.

### BACKGROUND OF THE INVENTION

Conventional signal selection systems and methods typically use one radio/transceiver or receiver for each signal to validate the signal. Beam validation analyzes the signal to decide whether the signal contains useful information or interference. Using one radio/transceiver for validating each signal is inefficient and cost prohibitive since a high number of signals generally require a corresponding large number of radios.

Moreover, other conventional signal selection systems and methods such as the receive signal strength indicator (RSSI) system and method, typically select signals based only on power. Hence, there is no validation of the signals to decide whether the signals contain useful information or interference.

Thus, a need exists in the industry to address the aforementioned deficiencies and inadequacies.

### SUMMARY OF THE INVENTION

The present invention provides a sequential signal selection system and method for pre-selecting at least two signals from a set of signals and then selecting at least one signal from the at least two signals.

Architecturally, one embodiment of the sequential signal selection system comprises a processor, a memory device that is coupled to the processor, at least one radio/transceiver that is coupled to the processor, and an analog pre-selection network that is coupled to the at least one radio/transceiver. Furthermore, the sequential signal selection method comprises pre-selecting at least two signals from a set of signals based on a pre-selection method, and selecting at least one signal from the at least two signals based on a selection method.

Other features and advantages of the present invention will be or become apparent to one having ordinary skill in the art upon examination of the following drawings and detailed description. It is intended that all such additional features and advantages be included with this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an exemplar sequential signal selection system.

FIG. 2 is a block diagram illustrating a first embodiment of the sequential signal selection system of FIG. 1.

FIG. 3 is a block diagram illustrating a second embodiment of the sequential signal selection system of FIG. 1.

FIG. 4 is a block diagram illustrating a third embodiment of the sequential signal selection system of FIG. 1.

FIG. 5 is a block diagram illustrating a first embodiment of an analog pre-select system located within the embodiments of the sequential signal selection illustrated in FIG. 1.

FIG. 6 is a block diagram illustrating a second embodiment of an analog pre-select located within the embodiments of the sequential signal selection system illustrated in FIG. 1.

FIG. 7 is a block diagram illustrating a third embodiment of an analog pre-select located within the embodiments of the sequential signal selection system illustrated in FIG. 1.

FIG. 8 is a flow chart of a sequential signal selection method that illustrates the functionality of the sequential signal selection system illustrated in FIG. 1.

### DETAILED DESCRIPTION OF THE PREFERRED EMBODIMENT

The sequential signal selection system and method overcomes the above-mentioned inadequacies and deficiencies since the number of radios need not be equal to the number of signals that are received by the sequential signal selection system. The sequential signal selection system and method uses a two step approach to reduce the number of radios relative to the number of signals received. First, there is a pre-selection of at least two signals from a set of signals that are received by the sequential signal selection system. The numbers of radios are equal to the number of signals that are pre-selected. Hence, there are at least two radios. The second step is to select at least one signal from the at least two signals that are pre-selected. Hence, the number of radios in the sequential signal selection system and method may not be equal to the number of signals in a set of signals that is received by the sequential signal selection system.

Furthermore, the sequential signal selection system and method overcomes the inadequacies and deficiencies when using only the RSSI system and method since it may pre-select at least two signals, from a set of signals, based on power. It may then select one signal from the at least two signals based on whether or not the at least one signal contains useful information or merely interference. Hence, the sequential signal selection system and method may obtain a signal that not only has the highest power among a set of signals but also contains useful information and not interference.

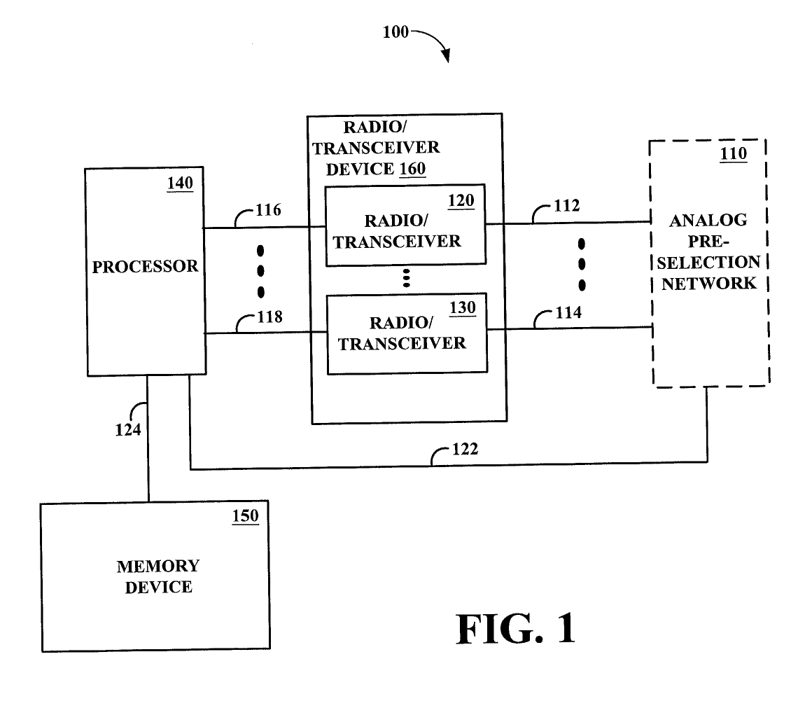

FIG. 1 is a block diagram illustrating an exemplar sequential signal selection system 100. The sequential signal selection system 100 comprises an analog pre-selection network 110, a radio/transceiver device 160, a processor 140 and a memory device 150. The radio/transceiver device 160 comprise a radio/transceiver 120, and a radio/transceiver 130. The radio/transceiver device 160 could comprise any number of radios/transceivers, where the number of radios/transceivers correspond to the number of signals that the analog pre-selection network 110 pre-selects. A line 112 couples the radio/transceiver 120 to the analog pre-selection network 110, and line 114 couples the radio/transceiver 130 to the analog pre-selection network 110. A line 116 couples the radio/transceiver 120 to the processor 140 and line 118 couples the radio/transceiver 130 to the processor 140. The number of lines coupling the radios/transceivers in the radio/transceiver device 160 is the same as the number of lines coupling the radios/transceivers in the radio/transceiver 160 to the analog pre-selection network 110. A line 122 couples the processor 140 to the analog pre-selection network 110 and a line 124 couples the processor 140 to the memory device 150.

It should be noted that each radio/transceiver 120 and 130 include devices, such as, but not limited to, an analog-to-digital converter, one or more filters, a digital-to-analog converter, and other devices known to those having ordinary skill in the art. Moreover, the processor 140 can be any processor known to those having ordinary skill in the art, and preferably, is a digital signal processor (DSP). Additionally, the memory device 150 can be any device, including, but not limited to, a register, a random access memory (RAM), or any other memory device that stores information and is known to those having ordinary skill in the art.

In operation, the analog pre-selection network 110 receives a set of signals from a transmission medium, and produces a corresponding set of signals, where each signal in the corresponding set of signals is a different linear combination of signals in the set of signals. The analog pre-selection network 110 then pre-selects at least two signals from the corresponding set of signals based on a pre-selection method such as, but not limited to, the RSSI method. The analog pre-selection network 110, however, may pre-select any number of signals from the set of signals. The radio/transceiver 160 receives the at least two signals from the analog pre-selection network 110. For instance, the radio/transceiver 120 receives a first signal, among the at least two signals, via the line 112, receives a second signal, among the at least two signals, via the line 114. The radio/transceiver 120 converts the first signal from an analog format to a digital format, and the radio/transceiver 130 converts the second signal from an analog format to a digital format. The radio/transceiver 120, and 130, may also perform other functionality on the first signal, and the second signal, including but not limited to, filtering the first signal and the second signal.

The processor 140 receives the at least two signals from the radio/transceiver device 160. For instance, the processor 140 receives the first signal, from the radio/transceiver 120, via line 116, and receives the second signal, from the radio/transceiver 160, via line 118. The processor 140 then selects two signals from the at least two signals, received from the radio/transceiver device 160, based on a selection method. The processor 140 may, alternatively, select two signals, from the set of signals, based on the selection method. The memory device 150 stores the selection method. It should be noted that the processor 140 may select any number of signals based on the selection method. It should also be noted that the analog pre-selection network 110 can receive any type of signals, known to those having ordinary skill in the art, including, but not limited to, radio/transceiver frequency (RF) signals, acoustic signals, optical signals, or infrared signals.

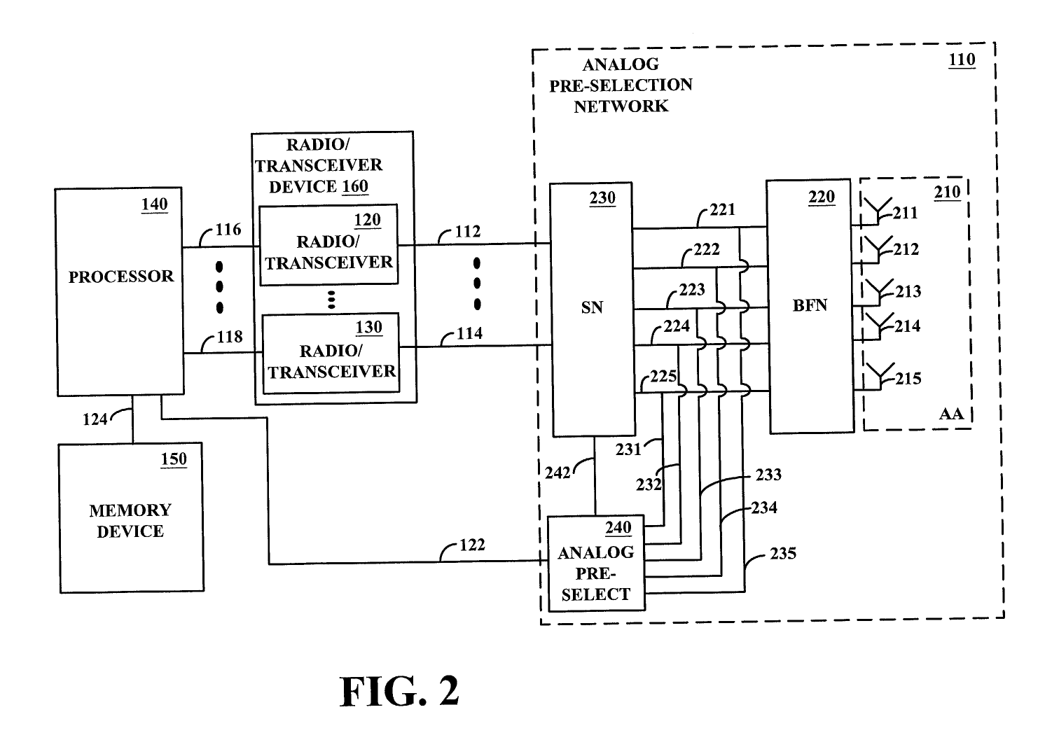

FIG. 2 illustrates a first embodiment of the sequential signal selection system 100 illustrated in FIG. 1. Specifically, the first embodiment comprises the analog pre-selection network 110 (FIG. 1), the radio/transceiver device 160 (FIG. 1), the processor 140 (FIG. 1) and the memory 150 (FIG. 1). The analog pre-selection network 110 further comprises an antenna array (AA)210 that includes antennas 211-215, a beamforming network (BFN) 220, a switching network (SN) 230, and an analog pre-select 240. The AA 210 may comprise any number of antennas and any kind of antennas known to those having ordinary skill in the art. The book, Robert J. Mailloux, Phased Array Antenna Handbook, 423-445 (1^{st} ed. 1994) illustrates a detailed description of an embodiment of the BFN 220. The SN 230 is a switching network that is known to those having ordinary skill in the art. In its simplest form, the SN 230 comprises five switches, where the five switches are coupled to the lines 221-225. Furthermore, the five switches are coupled to both the lines 112 and 114. The SN 230 can comprise of any number of switches, where the number of switches are the same as the number of lines coupling the BFN 220 to the SN 230. The lines 221-225 couple the SN 230, to the BFN 220. Lines 231-235 couple the lines 221-225 to the analog pre-select 240. A line 242 couples the analog pre-select 240 to the SN 230, and a line 122 couples the analog pre-select 240 to the processor 140.

The line 112 couples the radio/transceiver 120 to the SN 230 and the line 114 couples the radio/transceiver 130 to the SN 230. The number of lines coupling the radio/transceiver device 160 to the SN 230 is the same as the number of radios/transceivers in the radio/transceiver device 160, where the number of radios/transceivers in the radio/transceiver device 160 corresponds to the number of signals that the analog pre-select 240 pre-selects. The processor 140 is coupled to the two radios/transceivers 120 and 130, and to the memory device 150 in the same manner as described in FIG. 1.

The antennas 211-215 in the AA 210 receive a set of signals. The AA 210 can receive any number of signals, where the number of signals corresponds to the number of antennas in the AA 210. The BFN 220 changes the phase and/or amplitude of one or more signals in the set of signals and produces five signals, where each of the five signals is a different linear combination of signals in the set of signals. The BFN 220 may produce any number of signals and the number of lines 221-225 correspond to the number of signals that the BFN 220 produces. The number of lines 231-235 corresponds to the number of lines 221-225. The analog pre-select 240 receives the five signals via the lines 231-235. The analog pre-select 240 pre-selects at least two signals by calculating a first metric for each of the five signals, and then sorting at least two signals that have the best first metrics among the five signals. The analog pre-select 240 may pre-select any number of signals. The analog pre-select 240 then manipulates the SN 230 so that the at least two signals, among the five signals on lines 221-225, pass through the SN 230.

The radio/transceiver device 160 receives the at least two signals from the SN 230. For instance, the radio/transceiver 120 receives a first signal, among the at least two signals, via the line 112, and receives a second signal, among the at least two signals, via the line 114. The radio/transceiver 120 converts the first signal from an analog format to a digital format, and the radio/transceiver 130 converts the second signal from an analog format to a digital format. The radio/transceiver 120, and 130, may also perform other functionality on the first signal, and the second signal, including but not limited to, filtering the first signal and the second signal.

The processor 140 receives the at least two signals from the radio/transceiver device 160. For instance, the processor 140 receives the first signal, from the radio/transceiver 120, via line 116, and receives the second signal, from the radio/transceiver 160, via line 118. The processor 140 calculates a second metric for each of the at least two signals. The second metric can be based on correlating a code of each of the at least two signals to a pre-determined code, comparing the frequency of the envelope of each of the at least two signals to a pre-determined frequency, or calculating the bit error rate of each of the at least two signals.

A general goal of the sequential signal selection system and method is for the processor 140 to find a certain minimum number of signals that have an acceptable value of the second metric and then stop. Preferably, the minimum number of signals is two. The goal can be achieved by comparing the values of the second metric to a threshold. As soon as the minimum number of signals that meet the threshold, are found, the processor 140 commands the SN 230 to pass the minimum number of signals, and the sequential signal selection method ends. If the minimum number of signals that meet the threshold cannot be found, the desired minimum number of signals with the best values of second metrics are selected. A description of the sequential signal selection method that achieves the goal with a limited number of radios/transceivers within the radio/transceiver device 160, follows.

The processor 140 stores the second metrics of each of the at least two signals in the memory device 150, and tests the at least two signals by comparing the second metrics of each of the at least two signals to a certain threshold. If the processor 140 determines that at most one signal, of the at least two signals, has a second metric that meets the threshold, it sends a command via line 122 to the analog pre-select 240 to again pre-select at least two signals from the corresponding set of five signals. For instance, if the processor 140 calculates a bit error rate of a signal, meeting the threshold means that the bit error rate of the signal is lower than a threshold bit error rate. If the processor 140 compares the frequency of a signal to a pre-determined frequency, meeting the threshold can mean that a value representing the comparison is less than a threshold frequency value. If the processor 140 obtains a correlation of code of a signal to a pre-determined code, meeting the threshold can mean that the correlation of the signal is lower than a threshold correlation.

After the processor 140 sends the command, if the number of signals in the set of signals that are received by the AA 210, less the number of signals that have been tested by the processor 140, is not greater than one, the processor 140 simply commands the SN 230 to pass the untested signal in the set of five signals, and computes its second metric. The processor 140 then chooses two signals that have the best second metrics among the set of signals. Alternatively, if the processor 140 determines that the second metric of two or more signals among the at least two signals meets the threshold, the processor 140 selects two signals that have the best second metrics among the second metrics of the two or more signals.

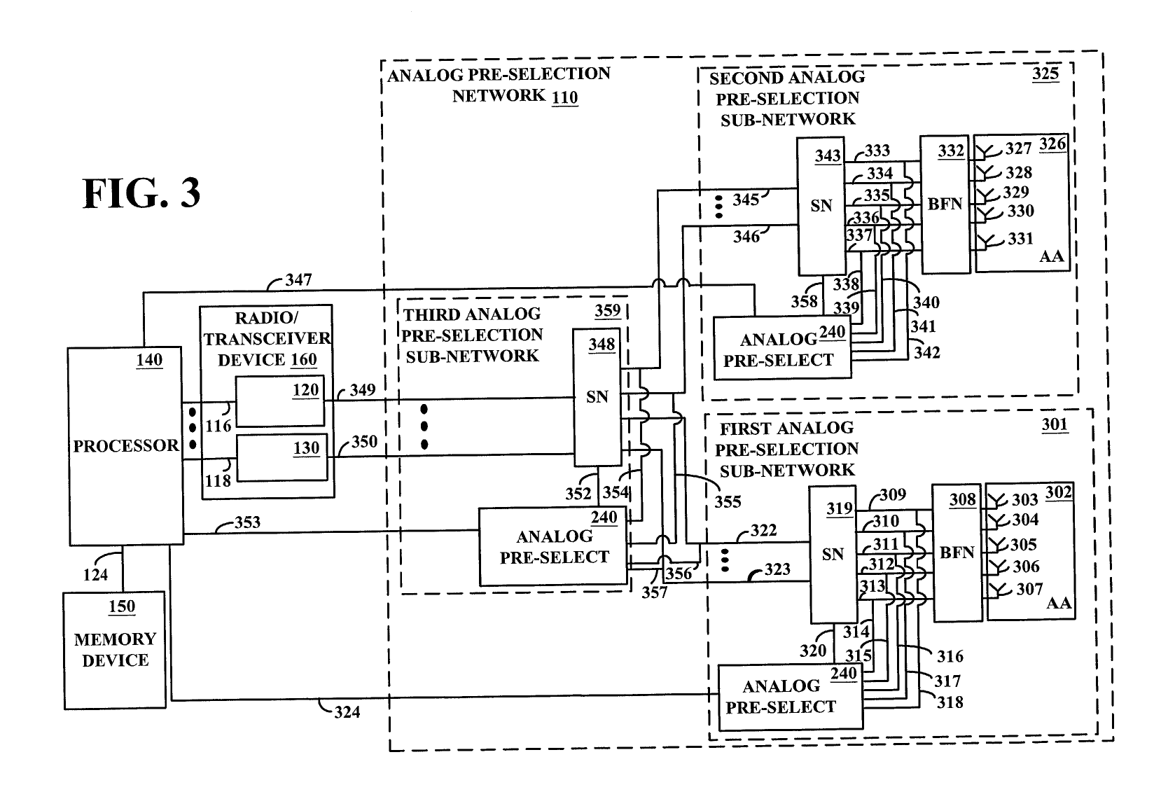

FIG. 3 illustrates a second embodiment of the sequential signal selection system 100 illustrated in FIG. 1. The second embodiment comprises the analog pre-selection network 110 (FIG. 1), the radio/transceiver device 160 (FIG. 1), the processor 140 (FIG. 1), and the memory device 150 (FIG. 1). The analog pre-selection network 110 comprises a first analog pre-selection sub-network 301, a second analog pre-selection sub-network 325, and a third analog pre-selection sub-network 359. The first analog pre-selection sub-network 301 comprises an SN 319, a BFN 308, an AA 302, and an analog pre-select 240. The AA 302 comprise five antennas 303-307 that are each coupled to the BFN 308. Lines 309-313 couple the SN 319 to the BFN 308. Additionally, lines 314-318 couple the lines 309-313 to the analog pre-select 240 located in the first analog pre-selection sub-network 301. Lines 322 and 323 couple the SN 319 to an SN 348. The number of lines that couple the SN 319 to the SN 348 is the same as the number of signals that the analog pre-select 240, in the first analog pre-selection sub-network 310, pre-selects. Line 320 couples the analog pre-select 240 to the SN 319 and a line 324 couples the analog pre-select 240 to the processor 140.

The second analog pre-selection network 325 comprises an SN 343, a BFN 332, an AA 326, and an analog pre-select 240. The AA 326 comprise five antennas 327-331 that are each coupled to the BFN 332. Lines 333-337 couple the SN 343 to the BFN 332. Furthermore, lines 338-342 couple the lines 333-337 to the analog pre-select 240 located in the second analog pre-selection sub-network 325. Lines 345 and 346 couple the SN 343 to the SN 348. The number of lines that couple the SN 343 to the SN 348 is the same as the number of signals that the analog pre-select, in the second analog pre-selection sub-network 325, pre-selects. Line 358 couples the analog pre-select 240, located in the second analog pre-selection sub-network 325, to the SN 343, and line 347 couples the analog pre-select 240, located in the second analog pre-selection sub-network 325, to the processor 140.

The third analog pre-selection sub-network 359 comprises the SN 348, and an analog pre-select 240. Line 354-355 couple the analog pre-select 240, located in the third analog pre-selection sub-network 359, to the lines 345-346. Lines 356-357 couple the analog pre-select 240, located in the third analog pre-selection sub-network 359, to the lines 322-323. A line 352 couples the analog pre-select 240 to the SN 348 and a line 353 couples the analog pre-select 240, located in the third analog pre-selection sub-network 359, to the processor 140. A line 349 couples the SN 348 to the radio/transceiver 120 and a line 350 couples the SN 348 to the radio/transceiver 130. The number of lines that couple the SN 348 to the radio/transceiver device 160 is the same as the number of signals that the analog pre-select, in the third analog pre-selection sub-network 359, pre-selects. The processor 140 is coupled to the radios 120 and 130, and to the memory device 150 in the same manner as illustrated in FIG. 1.

It should be noted that any number of antennas and any kind of antennas known to those having ordinary skill in the art, can be used in the AA 302 and in the AA 326. Furthermore, the BFN 308 and the BFN 332 may have the same structure as the BFN 220 (FIG. 2). Additionally, the SN 319, SN 343, and SN 348 may have the same structure as of the SN 230 (FIG. 2). However the SN 348 comprises four switches, where the four switches are coupled to the lines 345, 346, 322, and 323. Moreover, the four switches are coupled to both the lines 349 and 350. The number of switches in the SN 348 are the same as the total number of lines coupling the SN 319 and the SN 343 to the SN 348.

The antennas 303-307 in the AA 302 receive a first set of signals. The AA 302 can receive any number of signals, where the number of signals received corresponds to the number of antennas in the AA 302. The BFN 308 changes the phase and/or amplitude of one or more signals in the first set of signals and produces a corresponding first set of five signals, where each signal, in the corresponding first set five of signals, is a different linear combination of signals in the first set of signals. The BFN 308 may produce any number of signals, the number of lines 309-313 correspond to the number of signals that the BFN 308 produces, and the number of lines 314-318 correspond to the number of lines 309-313. The analog pre-select 240, in the first analog pre-selection sub-network 301, receives the five signals, in the corresponding first set of five signals, via the lines 314-318. The analog pre-select 240, in the first analog pre-selection sub-network 301, pre-selects at least two signals by calculating a first metric for each of the five signals, and sorting at least two signals from the five signals. The analog pre-select 240, in the first analog pre-selection sub-network 301, may sort any number of signals. The analog pre-select 240, in the first analog pre-selection sub-network 301, then manipulates the SN 319 so that the at least two signals, among the five signals on lines 314-318, pass through the SN 319.

The second analog pre-selection sub-network 325 performs in similar fashion as the first analog pre-selection sub-network 301, but on a second corresponding set of five signals that the BFN 332 produces and that correspond to a second set of signals that the AA 326 receives. The number of signals that the antennas in the AA 326 receive corresponds to the number of antennas in the AA 326. The analog pre-select 240, in the second analog pre-selection sub-network 325, selects at least two signals from the second corresponding set of five signals.

The third analog pre-selection sub-network 359 receives at least four signals, which include at least two signals sent from the SN 319, and at least two signals sent from the SN 319. For instance, assuming that the at least two signals sent from the SN 319 comprise a first signal and a second signal, the analog pre-select 240, in the third analog pre-selection sub-network 240, receives the first signal via the line 345, and receives the second signal via the line 323. Moreover, assuming that the at least two signals sent from the SN 343 comprise a third and a fourth signal, the analog pre-select 240, in the third analog pre-selection sub-network 240, receives the third signal via the line 345, and receives the fourth signal via the line 346.

The analog pre-select 240, in the third analog pre-selection sub-network 359, pre-selects at least two signals from the at least four signals, by calculating a first metric for each of the at least four signals based on a method, including, but not limited to, the RSSI method, a correlation method, or a frequency comparison method. The correlation method compares codes, such as, but not limited to, bit patterns, of each signal among the at least four signals, to a pre-determined code. The frequency comparison method compares frequency of the envelope of each signal among the at least four signals to a pre-determined frequency.

The analog pre-select 240, in the third analog pre-selection sub-network 359, continues to pre-select by sorting at least two signals, from the at least four signals, based on first metrics. The at least two signals that are sorted from the at least four signals have the best first metrics among the first metrics of the at least four signals. The analog pre-select 240, in the third analog pre-selection sub-network 359, then manipulates the SN 348 so that only the at least two signals having the best first metrics from the at least four signals pass through the SN 348. The radio/transceiver device 160 receives the at least two signals from the SN 348. For instance, the radio/transceiver 120 receives a signal, via the line 349, among the at least two signals sent from the SN 343. Moreover, the radio/transceiver 130 receives a signal, via the line 350, among the at least two signals sent from the SN 319. The radio/transceiver 120 converts the signal that it receives, via line 349, from an analog format to a digital format, and the radio/transceiver 130 converts the signal that it receives, via line 350, from an analog format to a digital format. The radio/transceiver 120, and 130, may also perform other functionality on the signals that they receive, including but not limited to, filtering the signals. The processor 140 receives the at least two signals from the at least four signals via the lines 116 and 118. For instance, the processor 140 receives a signal sent from the radio/transceiver 120 via line 116, and receives a signal sent from the radio/transceiver 160 via line 118.

The processor 140 receives the at least two signals from the radio/transceiver device 160, and selects two signals from the at least two signals. The processor 140 calculates second metrics for the at least two signals. The second metrics can be based on correlating a code of each of the at least two signals to a pre-determined code, comparing the frequency of the envelope of each of the at least two signals to a pre-determined frequency, or computing bit error rates of each of the at least two signals. The processor 140 stores the second metrics of the at least two signals in the memory device 150. The processor 140 then tests the at least two signals by comparing the second metrics of the at least two signals to a certain threshold.

If the processor 140 determines that at most one signal of the at least two signals has a second metric that meets the threshold, it sends a command via line 324 to the analog pre-select 240, in the first analog pre-selection sub-network 301, to again pre-select at least two signals from the corresponding first set of five signals. Furthermore, the processor 140 also sends the command via line 347 to the analog pre-select 240, in the second analog pre-selection sub-network 325, to again pre-select at least two signals from the corresponding second set of five signals. Moreover, the processor 140 sends a command via line 353 to the analog pre-select 240, in the third analog pre-selection sub-network 359, to again pre-select at least two signals from the at least four signals that the analog pre-select 240, in the third analog pre-selection network 359, receives via lines 354-357. The processor 140 could send commands to any one or more of the analog pre-selects 240 in the first, second and third analog pre-selection sub-networks.

After the processor 140 sends the commands via the lines 324, 347, and 353, if the total number of signals, in the corresponding first and second sets of five signals, which are received by the AAs 302 and 326, less the number of signals that have been tested by the processor 140 is not greater than one, the processor 140 simply commands the SNs 343, 319, and 348 to pass the untested signal in the corresponding first and second sets of five signals, and computes its second metric. Then the processor 140 chooses two signals that have the best second metrics among the signals in the corresponding first and the second sets of five signals. Alternatively, if the processor 140 determines that the second metrics of two or more signals among the at least two signals meets the threshold, the processor 140 selects two signals that have the best second metrics among the two or more signals.

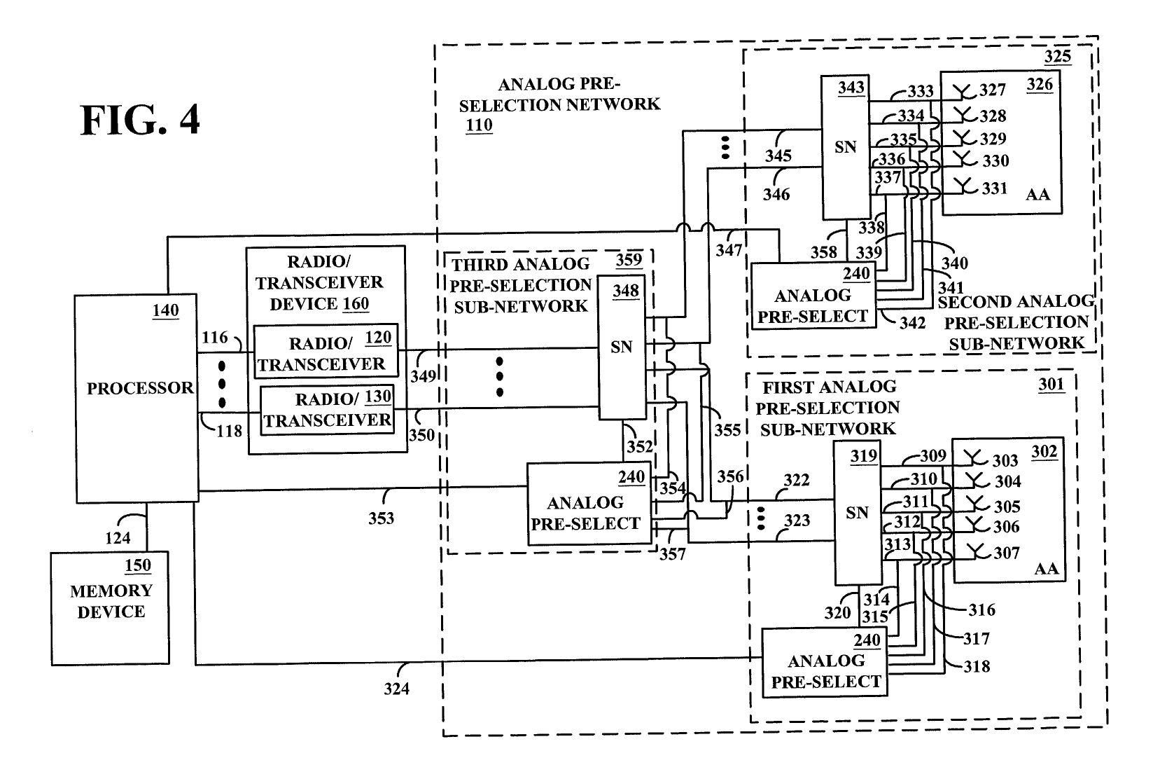

FIG. 4 illustrates a third embodiment of the sequential signal selection system 100 illustrated in FIG. 1. Structurally, the sequential signal selection system of FIG. 4 is similar that of FIG. 3, except for the following. In the second analog pre-selection sub-network 325, the lines 333-337 directly couple the SN 343 to the antennas 327-331 in the AA 326. Moreover, the lines 338-342 couple the lines 333-337 to the analog pre-select 240 located in the second analog pre-selection sub-network 325. Furthermore, in the first analog pre-selection sub-network 301, the lines 309-313 directly couple the SN 319 to the antennas 303-307 in the AA 302. Additionally, the lines 314-318 couple the lines 309-313 to the analog pre-select 240 located in the first analog pre-select sub-network 301.

The third embodiment of sequential signal selection system 100 has the same functionality as the second embodiment of the analog pre-selection sub-network 110 (FIG. 3) except for the following changes. There is no manipulation of the phase and/or amplitude of a first set of signals received by the AA 302 since there is no BFN coupled to the AA 302. Therefore, the first set of signals that are received by the AA 302 go directly to the SN 319 and to the analog pre-select 240 in the first analog pre-selection sub-network 301. Moreover, a second set of signals that are received by the AA 326 go directly to the SN 343 and the analog pre-select 240, in the second analog pre-selection sub-network 325, since there is no BFN coupled to the AA 326 to manipulate the phase and/or amplitude of each signal in the second set of signals.

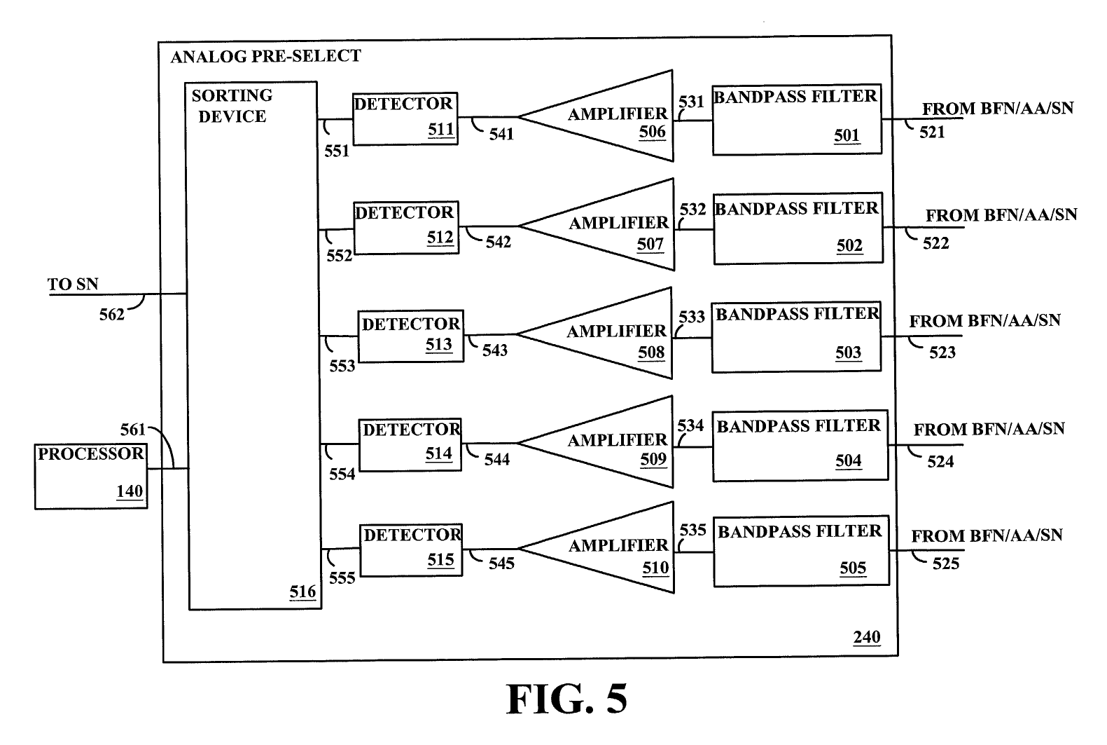

FIG. 5 illustrates a first embodiment of the analog pre-select 240 of FIGS. 2-4. The analog pre-select 240 comprises detectors 511-515, amplifiers 506-510, bandpass filters 501-505 and a sorting device 516. Lines 521-525 are represented as lines 231-235 in FIG. 2, as lines 338-342 in FIGS. 3 and 4, and as lines 314-318 in FIGS. 3 and 4.

Any number of detectors, amplifiers and bandpass filters can be used in the analog pre-select 240. The number of detectors, amplifiers and bandpass filters are the same as the number of signals that the analog pre-select 240 receives. For instance, the analog pre-select 240, as located within the analog pre-selection network 110 in FIG. 2, within the first analog pre-selection sub-network 301 in FIGS. 3 and 4, or within the second analog pre-selection sub-network 325 in FIGS. 3 and 4, receives five signals. The analog pre-select 240, therefore, includes five detectors, five amplifiers, and five bandpass filters. Alternatively, the analog pre-select 240 as located within the third analog pre-selection sub-network 359 in FIGS. 3 and 4, receives four signals, and therefore includes four detectors, four amplifiers, and four bandpass filters.

Lines 531-535 couple the bandpass filters 501-505 to the amplifiers 506-510, respectively. For instance, the line 531 couples the bandpass filter 501 to the amplifier 506. Furthermore, lines 541-545 couple the amplifiers 506-510 to the detectors 511-515, respectively. As an example, line 541 couples the amplifier 506 to the detector 511. Additionally, lines 551-555 couple the detectors 511-515 to the sorting device 516. Specifically, the line 551 couples the detector 511 to the sorting device 516. Line 561 couples the sorting device 516 to the processor 140. Line 561 corresponds to line 122 in FIG. 2, line 324 in FIGS. 3 and 4, and line 347 in FIGS. 3 and 4. Line 562 couples the sorting device 516 to an SN. To explain, line 562 corresponds to line 242 in FIG. 2, and to lines 320, 358 and 352 in FIGS. 3 and 4.

The analog pre-select 240 pre-selects at least two signals from a set of signals as follows. Each of the bandpass filters 501-505 receives a signal from the set of signals and filters the signal. The bandpass filters 501-505 can be any filter, including but not limited to, a high pass filter, a low pass filter, or any other filter known to those having ordinary skill in the art. Each of the amplifiers 506-510 receives a signal, from the set of signals, via lines 531-535 and amplifies the signal. Each of the detectors 511-515 receives a signal, among the set of signals, via lines 541-545 and creates a first metric of the signal by rectifying the signal. The first metric is an approximation of amplitude of a signal, among the set of signals, and the amplitude provides an indication of signal strength. Each of the detectors 511-515 can be any device that is known to those having ordinary skill in the art and that rectifies a signal such as, for instance, a diode. The sorting device 516 receives the set of signals, via lines 551-555, and sorts at least two signals that have the best first metrics, such as, for instance, the highest amplitude among the signals in the set of signals. The sorting device 516 manipulates an SN via the line 562 so that the SN allows only the at least two signals that are pre-selected, to pass through.

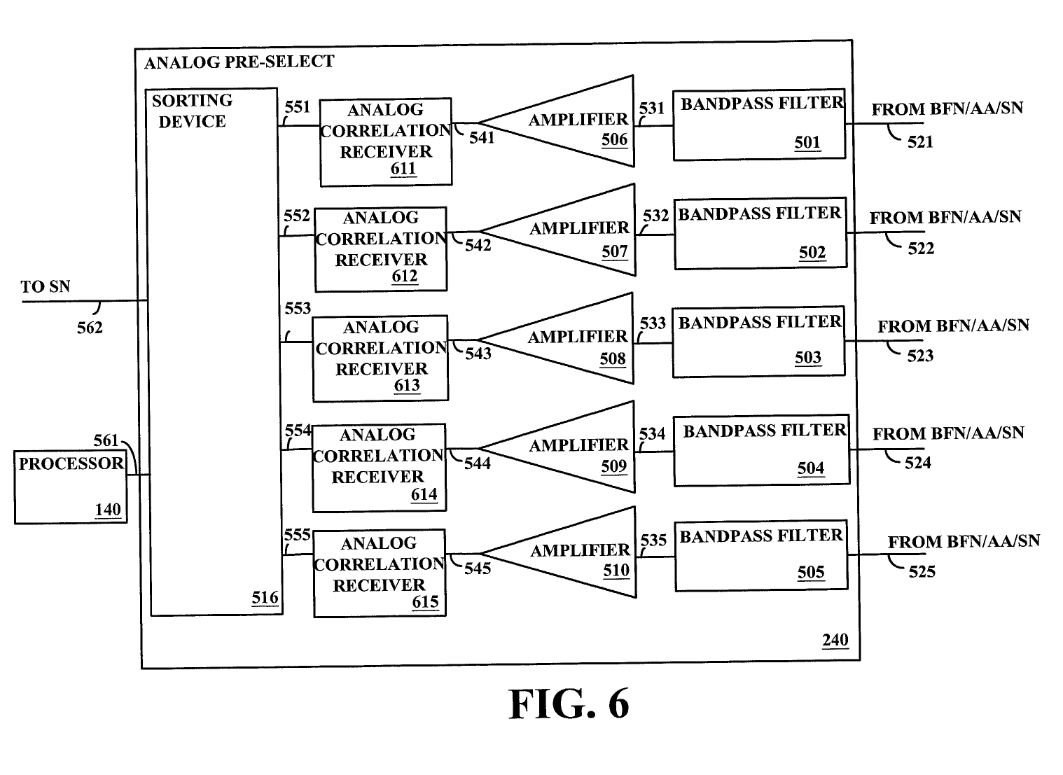

FIG. 6 illustrates a second embodiment of the analog pre-select 240 illustrated in FIGS. 2-4. The second embodiment of the analog pre-select 240 is similar to the first embodiment illustrated in FIG. 5, except that the analog correlation receivers 611-615 replace the detectors 511-515 (FIG. 5). Any number of analog correlation receivers can be used. The number of analog correlation receivers are the same as the number of signals in the set of signals that the analog pre-select 240 receives. For instance, the analog pre-select 240, as located within the analog pre-selection network 110 in FIG. 2, within the first analog pre-selection sub-network 301 in FIGS. 3 and 4, or within the second analog pre-selection sub-network 325 in FIGS. 3 and 4, comprise five analog correlation receivers. Alternatively, the analog pre-select 240, as located within the third analog pre-selection sub-network 359 in FIGS. 3 and 4, comprise four analog correlation receivers.

A description of the functionality of the second embodiment of the analog pre-select 240 follows. Each of the bandpass filters 501-505 and the amplifiers 506-510 receive a set of signals comprising five signals and perform the same functions as described in the first embodiment of the analog pre-select 240 in FIG. 5. Each of the analog correlation receivers 611-615 receives a signal among the set of signals and calculates a first metric for the signal. The first metric for each signal among the set of signals represents a correlation of a code, such as, but not limited to, a bit pattern, of each signal among the set of signals, to a pre-determined code. The sorting device 516 receives the set of signals and pre-selects at least two signals having a higher correlation among the signals in the set of signals. The sorting device 516 then manipulates an SN via the line 562 so that only the at least two signals that are pre-selected from the set of signals, pass through the SN.

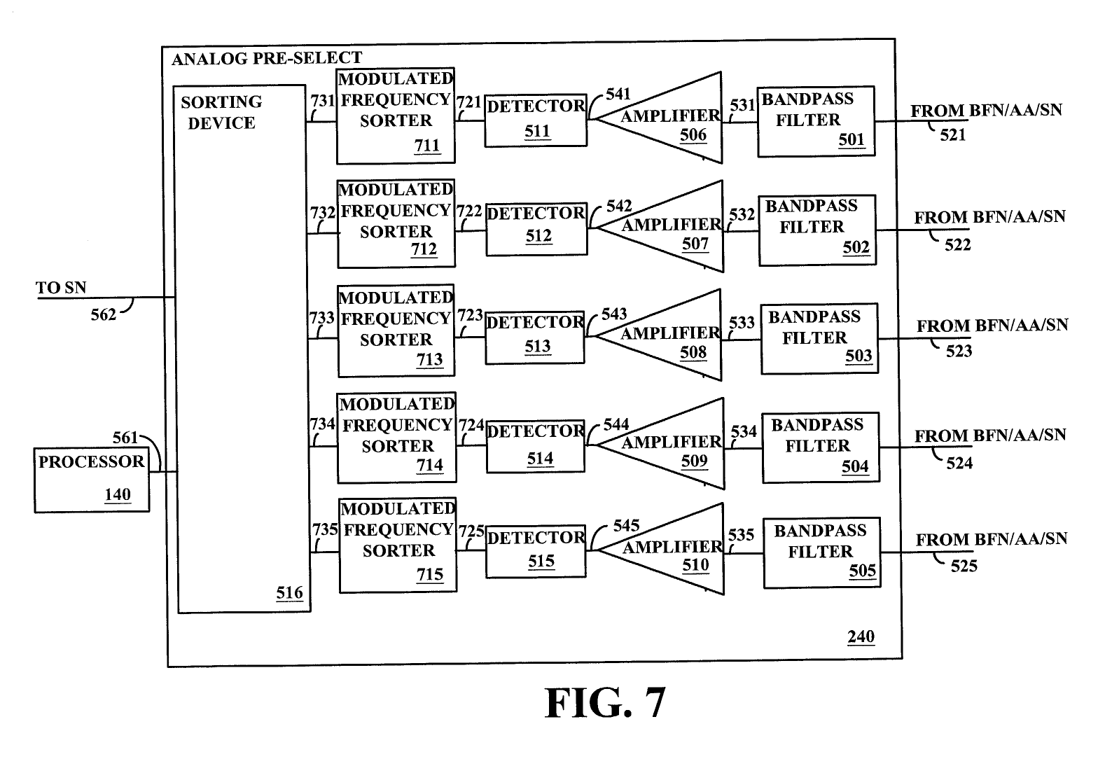

FIG. 7 illustrates a third embodiment of the analog pre-select 240 illustrated in FIGS. 2-4. Structurally, the third embodiment of the analog pre-select 240 is similar to the first embodiment of the analog pre-select 240 illustrated in FIG. 5, except that the third embodiment includes modulated frequency sorters 711-715. Lines 721-725 couple the modulated frequency sorters 711-715 to the detectors 511-515. For instance, line 721 couples the modulated frequency sorter 711 to the detector 511. Moreover, lines 731-735 couple the sorting device 516 to the modulated frequency sorters 711-715. As an example, the line 731 couples the sorting device 516 to the modulated frequency sorter 711.

Any number of modulated frequency sorters can be used. The number of modulated frequency sorters is the same as the number of signals that the analog pre-select 240 receives. For instance, the analog pre-select 240, as located within the analog pre-selection network 110 in FIG. 2, within the first analog pre-selection sub-network 301 in FIGS. 3 and 4, or within the second analog pre-selection sub-network 325 in FIGS. 3 and 4, comprise five modulated frequency sorters. Alternatively, the analog pre-select 240, as located within the third analog pre-selection sub-network 359 in FIGS. 3 and 4, comprise four modulated frequency sorters.

The analog pre-select 240 pre-selects as follows. Each of the bandpass filters 501-505, the amplifiers 506-510, and the detectors 511-515 perform the same operation, as described in FIG. 5, on each signal in a set of signals that are received by the analog pre-select 240. Additionally, each of the modulated frequency sorters 711-715 receives each signal among the set of signals via lines 721-725 and calculates a first metric based on a comparison of frequency of the envelope of each signal to a pre-determined frequency. The sorting device 516 receives each signal among the set of signals via lines 731-735 and sorts at least two signals from the set of signals based on the first metric. In other words, the sorting device 516 sorts at least two signals whose envelopes have frequencies that are closest to the pre-determined frequency, among the frequencies of signals in the set of signals. The sorting device 516 then manipulates an SN via line 562 so that the SN allows only the at least two signals to pass through.

However, if the analog pre-select 240 in FIGS. 5-7 is located within the third analog pre-selection sub-network 359 as illustrated in FIGS. 3 and 4, the analog pre-select 240 pre-selects at least two signals from at least four signals that are pre-selected within the first pre-selection subnetwork 301 and within the second pre-selection subnetwork 325 (FIGS. 3 and 4).

The analog pre-select 240 as illustrated in FIGS. 2-7 can be implemented in hardware, software, firmware or a combination thereof. The analog pre-select 240 (FIGS. 2-7) can be implemented in software or firmware that is stored in a memory and that is executed by suitable instruction execution system. The analog pre-select 240 (FIGS. 2-7) can be implemented, preferably in hardware, with any or a combination of the following technologies which are well known in the art: a discrete logic circuit(s) having logic gates for implementing logic functions upon data signals, and applications specific integrated circuit (ASIC) having appropriate combinational logic gates, a programmable gate array(s) (PGA), a field programmable gate array (FPGA), etc.

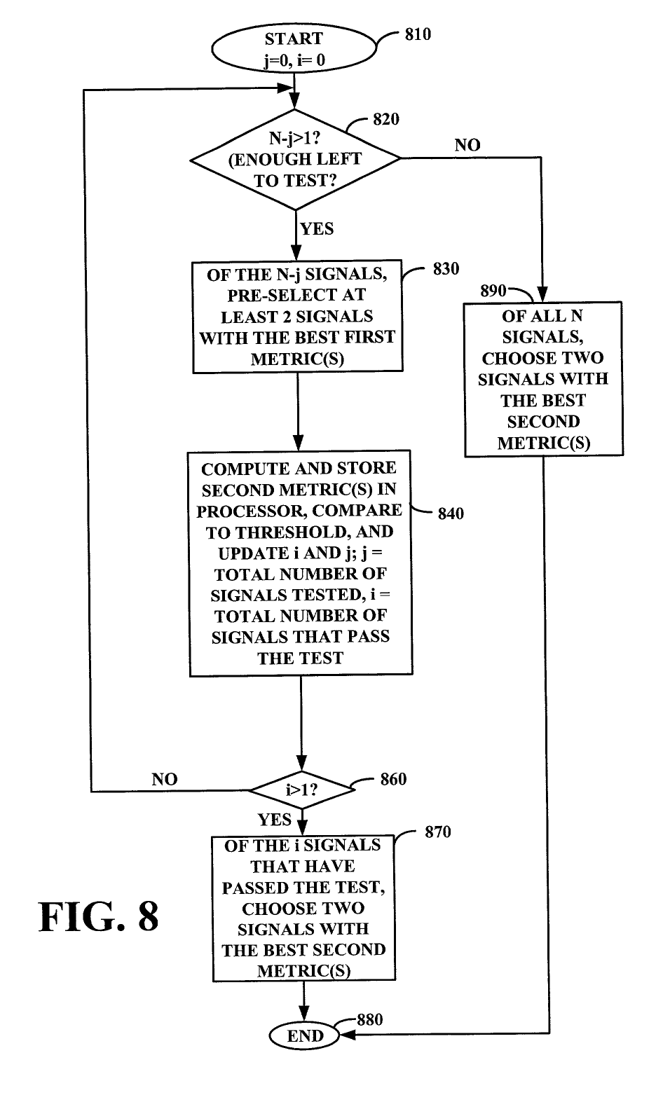

FIG. 8 illustrates a sequential signal selection method for selecting two signals from a set of more than two signals that are received by the analog pre-selection network 110 (FIGS. 1-4). N represents the total number of signals that are received by the analog pre-selection network 110 (FIGS. 1-4). The sequential signal selection method starts with a step 810, where j=0, and j is a total number of signals that the processor 140 (FIGS. 1-4) has tested from the at least two signals received via lines 116 and 118 (FIGS. 2, 3 and 4). The starting step 810 also comprises an i=0, where i is a total number of signals among j that pass the test.

The following step 820 determines whether or not N less j is greater than 1. In other words, step 820 determines if there are two or more signals that are left to be tested by the processor 140 (FIGS. 1-4). If there are two or more signals left to be tested by the processor 140 (FIGS. 1-4), in block 830, at least two signals are pre-selected from the N−j signals. However, any number of signals can be pre-selected from the N−j signals. The at least two signals that are pre-selected in the analog pre-select 240 (FIGS. 2-4) have the best first metrics among the first metrics of the N−j signals. As illustrated in FIG. 6, the analog correlation receiver 611-615 calculates the first metric that represents a correlation between a code of each signal in the N−j signals, and a pre-determined code, and then the sorting device 516 (FIG. 6) sorts at least two signals from the N−j signals, where each of the at least two signals, among the N−j signals, have the highest correlation to the pre-determined code. Alternatively, as illustrated in FIG. 7, modulated frequency sorters 711-715 calculate a first metric of each of the N−j signals, where the first metric represents the nearness of the frequency of the envelope of each of the N−j signals to a pre-determined frequency. The sorting device 516 (FIG. 7) sorts at least two signals from the N−j signals, where each of the at least two signals have the best first metrics among the N−j signals. Moreover, any method that is known to those having ordinary skill in the art can be used to calculate the first metrics, or to sort the at least two signals from the N−j signals.

Once the analog pre-select 240 (FIGS. 2-4) pre-selects at least two signals from the N−j signals, in block 840, the processor 140 (FIGS. 1-4) computes a second metric for each of the at least two signals and stores the second metric in the memory device 150 (FIGS. 1-4). The processor 140 (FIGS. 1-4) computes the second metric based on for instance, a correlation of a code of each of the at least two signals to a pre-determined code, a comparison of frequency of the envelopes of each of the at least two signals to a pre-determined frequency, a computation of bit error rate of each of the at least two signals, or any other method of comparison known to those having ordinary skill in the art. Thereafter, the processor 140 (FIGS. 1-4) tests the at least two signals by comparing the second metrics to a threshold. The processor 140 (FIGS. 1-4) updates j so that j represents the total number of signals that have been tested among the N signals. The processor 140 (FIGS. 1-4) also updates i so that i represents the total number of signals among the j signals that pass the test administered by the processor 140.

The step 860 determines whether the total number of signals i that pass the test administered in the processor 140 (FIGS. 1-4), is greater than 1. If so, in step 870, the processor 140 (FIGS. 1-4) chooses two signals among the i signals, where each of the two signals have the best second metrics among the i signals. The processor 140 (FIGS. 1-4) may choose any number of signals among the i signals. Once the two signals that have the best second metrics among the i signals, are chosen in step 870, the sequential signal selection method ends in step 880.

If the total number of signals i that pass the test that is administered in the processor 140 (FIGS. 1-4) is not greater than 1, the step 860 loops back to the step 820. The step 860 keeps on looping back to the step 820 till i, which is the total number of signals that pass the test, is greater than 1. If the total number of signals N less the total number of signals that have been tested, j, is not greater than 1, step 890 follows from step 820. In step 890, the processor 140 (FIGS. 1-4) chooses two signals among the N signals, where the two signals have the best second metrics among the second metrics of the N signals. The processor 140 (FIGS. 1-4) may choose any number of signals among the N signals. The sequential signal selection method then ends in the step 880.

Any process descriptions or blocks in FIG. 8 should be understood as representing modules, segments, or portions of code which include one or more executable instructions for implementing specific logical functions or steps in the sequential signal selection system and method, and alternative implementations are included within the scope of an embodiment of the sequential signal selection system and method in which functions may be executed out of order from that shown or discussed in FIG. 8, including substantially concurrently or in reverse order, depending on the functionality involved, as would be understood by those reasonably skilled in the art of the sequential signal selection system and method.

It should be emphasized that the above-described embodiments of the sequential signal selection system and method, particularly, any “preferred” embodiments, are merely possible examples of implementations, merely set forth for a clear understanding of the principles of the sequential signal selection system and method. Many variations and modifications may be made to the above-described embodiment(s) of the sequential signal selection system and method without departing substantially from the spirit and principles of the sequential signal selection system and method. All such modifications and variations are intended to be included herein within the scope of this disclosure and the sequential signal selection system and method and protected by the following claims.

Therefore, having thus described the invention, at least the following is claimed:

1. A sequential signal selection system comprising:
a processor;
a memory device coupled to the processor;
at least one radio/transceiver coupled to the processor; and
an analog pre-selection network coupled to the at least one radio/transceiver.

2. The sequential signal selection system of claim 1, wherein the analog pre-selection network comprises:
a beam forming network;
an antenna array coupled to the beam forming network;
a switching network coupled to the beam forming network; and
an analog pre-select coupled to the switching network, and to the beam forming network.

3. The sequential signal selection system of claim 1, wherein the analog pre-selection network comprises:
a first analog pre-selection sub-network;
a second analog pre-selection sub-network; and
a third analog pre-selection sub-network coupled to the first analog pre-selection sub-network, and to the second analog pre-selection sub-network.

4. The sequential signal selection system of claim 3, wherein the third analog pre-selection sub-network comprises:
a third switching network coupled to the at least one radio/transceiver; and
a third analog pre-select coupled to the third switching network.

5. The sequential signal selection system of claim 4, wherein the second analog pre-selection sub-network comprises:
a second switching network coupled to the third switching network;
a second beamforming network coupled to the second switching network, the second beam forming network coupled to a second antenna array; and
a second analog pre-select coupled to the second beam forming network, to the second switching network, and to the processor.

6. The sequential signal selection system of claim 5, wherein the first analog pre-selection sub-network comprises:
a first switching network coupled to the third switching network;
a first beam forming network coupled to the first switching network, the first beam forming network coupled to a first antenna array; and
a first analog pre-select coupled to the first beam forming network, to the first switching network, and to the processor.

7. The sequential signal selection system of claim 4, wherein the second analog pre-selection sub-network comprises:
a second switching network coupled to the third switching network, the second switching network coupled to a second antenna array; and
a second analog pre-select coupled to the second antenna array, and to the second switching network.

8. The sequential signal selection system of claim 7, wherein the second analog pre-select is coupled to the processor.

9. The sequential signal selection system of claim 8, wherein the first analog pre-selection sub-network comprises:
a first switching network coupled to the third switching network; the first switching network coupled to a first antenna array; and
a first analog pre-select coupled to the first antenna array, to the first switching network, and to the processor.

10. The sequential signal selection system of claim 2, wherein the analog pre-select comprises:
a band pass filter, the band pass filter coupled to the beam forming network;
an amplifier coupled to the band pass filter;
a detector coupled to the amplifier; and
a sorting device coupled to the detector, to the processor, and to the switching network.

11. The sequential signal selection system of claim 2, wherein the analog pre-select comprises:
a band pass filter coupled to the beam forming network;
an amplifier coupled to the band pass filter;
an analog correlation receiver coupled to the amplifier; and
a sorting device coupled to the analog correlation receiver, to the processor, and to the switching network.

12. The sequential signal selection system of claim 2, wherein the analog pre-select comprises:
a band pass filter, the band pass filter coupled to the beam forming network;
an amplifier coupled to the band pass filter;
a detector coupled to the amplifier;
a modulated frequency sorter coupled to the detector; and
a sorting device coupled to the modulated frequency sorter, to the switching network, and to the processor.

13. A sequential signal selection method, comprising the steps of:
pre-selecting at least two signals from a set of signals based on a pre-selection method; and
selecting at least one signal from the at least two signals based on a selection method.

14. The sequential signal selection method of claim 13, wherein the pre-selection method is a receive signal strength indicator method.

15. The sequential signal selection method of claim 13, wherein the pre-selection method comprises the steps of:
filtering the set of signals;
amplifying the set of signals;
rectifying the set of signals; and
sorting the set of signals to obtain the at least two signals.

16. The sequential signal selection method of claim 13, wherein the pre-selection method comprises the steps of:
filtering the set of signals;
amplifying the set of signals;
comparing a code of each signal in the set of signals to a pre-determined code; and
sorting the set of signals to obtain the at least two signals.

17. The sequential signal selection method of claim 13, wherein the pre-selection method comprises the steps of:
filtering the set of signals;
amplifying the set of signals;
comparing frequency of envelope of each signal in the set of signals to a pre-determined frequency; and
sorting the set of signals to obtain the at least two signals.

18. The sequential signal selection method of claim 13, wherein the set of signals comprises a set of radio frequency signals, a set of acoustic signals, a set of optical signals, and a set of infrared signals.

19. The sequential signal selection method of claim 13, wherein the selection method comprises the steps of:
comparing the at least two signals to a threshold; and
sorting the at least two signals to obtain the at least one signal, wherein the at least two signals meet the threshold.

20. A sequential signal selection system, comprising:
means for pre-selecting at least two signals from a set of signals based on a pre-selection method; and
means for selecting at least one signal from the at least two signals based on a selection method.
